(19) United States
(12) Patent Application Publication
(10) Pub. No.: US 2025/0004120 A1
(43) Pub. Date: Jan. 2, 2025

(54) Stereo 4D Radar Vision System and Method

(71) Applicant: Ynjiun Paul Wang, Cupertino, CA (US)

(72) Inventor: Ynjiun Paul Wang, Cupertino, CA (US)

(21) Appl. No.: 18/214,824

(22) Filed: Jun. 27, 2023

(51) Int. Cl. G01S 13/42; G01S 13/931

(52) U.S. Cl. CPC G01S 13/426; G01S 13/931; G01S 2013/0254

(57) ABSTRACT

A stereo 4D radar vision system comprises a stereo vision system and a 4D radar system. The stereo vision system consists of two cameras with a field of view FOV1 and a baseline B1. The 4D radar system has a transmitter antenna array and a receiver antenna array forming a scanning field of view FOV2. The overlap between FOV1 and FOV2 ranges from 0.3 meter to 300 meters. The field of view FOV1 has higher pixel resolutions than FOV2. The center of the stereo vision system's field of view FOV1 is at a distance of less than 20 cm away from the center of the 4D radar system's field of view FOV2.

### BACKGROUND

Perception systems play a crucial role in various fields, including autonomous vehicles, robotics, and surveillance. Among the popular sensor technologies utilized in perception systems, stereo vision, 4D radar, and LiDAR (Light Detection and Ranging) have gained significant attention in recent developments.

Stereo vision sensors in automotive applications not only provide depth perception but also offer high-resolution image processing of road scenes, providing rich information about the road environment that other sensors, such as radar or LiDAR, may struggle to obtain. Cameras are currently used in certain vehicles for lane detection, lane keeping assistance, lane departure warning systems, and automatic traffic sign recognition. Furthermore, with recent advancements in artificial intelligence, cameras can now detect pedestrians or cyclists, which radar or LiDAR sensors may fail to do. Another advantage of stereo vision sensors is their cost-effectiveness, making them accessible for various applications.

However, stereo vision systems have several limitations. One limitation is that depth estimation accuracy decreases with distance, making stereo vision less effective for long-range perception. Additionally, stereo vision heavily relies on image matching, making it susceptible to challenges posed by varying lighting conditions and textureless surfaces. Objects that are occluded or have ambiguous disparities can also be challenging for stereo vision to accurately perceive.

The recent advancement of 4D radar combines traditional radar technology with additional capabilities such as elevation and velocity measurements. It emits radio waves and analyzes their reflection to detect and track objects in the environment. 4D radar excels in long-range detection, making it effective for applications requiring early detection of objects at a distance. Moreover, radar is not affected by adverse weather conditions or lighting variations, ensuring reliable performance in challenging environments.

However, 4D radar also has its limitations. Radar systems generally have lower spatial resolution compared to other technologies, making it challenging to discern fine details or accurately localize objects. Radar primarily provides information about an object's position, velocity, and size but lacks the ability to classify objects based on their appearance or shape. Radar signals can be affected by interference from other radar systems, electromagnetic noise, or reflective surfaces, leading to potential false detections or reduced accuracy.

LiDAR systems emit laser beams and measure the time it takes for the light to reflect back, allowing for precise distance measurements and 3D point cloud generation. LiDAR has much higher spatial resolution than 4D radar and provides detailed and accurate 3D point cloud data, enabling precise object localization and mapping of the environment. LiDAR can operate effectively in various lighting conditions and is not affected by color or texture variations, making it reliable in different scenarios.

However, LiDAR technology tends to be more expensive compared to stereo vision and radar, which can limit its adoption in cost-sensitive applications. LiDAR also has limited range in certain conditions. Adverse weather conditions such as heavy rain, snow, or fog can reduce the effective range and accuracy of LiDAR. Furthermore, LiDAR is sensitive to reflective surfaces. Highly reflective surfaces like mirrors or glass can cause issues with LiDAR, leading to erroneous readings or incomplete point cloud data.

Stereo vision, 4D radar, and LiDAR are valuable perception technologies, each with its own set of strengths and limitations. Stereo vision offers cost-effective depth perception high spatial pixel resolution but struggles with long-range detection and challenging lighting conditions. 4D radar excels in long-range perception but lacks spatial resolution and object classification abilities. LiDAR provides high-resolution 3D point cloud data and object classification but can be costly and sensitive to certain environmental conditions.

Therefore, there is an unmet need for a cost-effective, long-range, high spatial resolution, evidenced-based, 4D detection and ranging system that can thrive in challenging lighting and adverse weather conditions while supporting advanced object detection, classification, and scene segmentation using state-of-the-art artificial intelligence technologies.

### SUMMARY OF THE INVENTION

In one aspect, a stereo 4D radar vision system comprises a stereo vision system and a 4D radar system. The stereo vision system consists of two cameras with a field of view FOV1 and a baseline B1. The 4D radar system has a transmitter antenna array and a receiver antenna array forming a scanning field of view FOV2. The overlap between FOV1 and FOV2 ranges from 0.3 meter to 300 meters.

Also the field of view FOV1 overlaps with more than 30% of the area of FOV2 in the range from 0.3 meter to 300 meters.

Moreover, the field of view FOV1 has higher pixel resolutions than FOV2.

One of the preferred configurations for the invented stereo 4D radar vision system is to mount the center of the stereo vision system's field of view FOV1 at a distance of less than 20 cm away from the center of the 4D radar system's field of view FOV2.

A method of enhanced pixel resolution 4D ranging and detection using a stereo 4D radar vision system, comprising: Acquiring stereo images using a stereo vision system at enhanced pixel resolution, Detecting object distance and velocity using a 4D radar system at scanning resolutions, Determining a disparity search range of the detected object based on the object distance detected by the 4D radar system, Computing the detected object disparity within the disparity search range using a stereo vision system at enhanced pixel resolutions, Outputting at least one of a pixel-based disparity map, a pixel-based distance map, and 4D point clouds of the detected object with enhanced resolutions.

The method of determining a disparity search range of a detected object boundary can be further refined by computing instance segmentation mask of the stereo images using the state of the art panoptic segmentation combined deep learning with advanced network architectures including convolutional neural networks (CNN) and encoder-decoder structures.

If the panoptic segmentation detects a reduced visibility in adverse weather conditions, such as fog, rain, snow, or extremely dark environments, the stereo 4D radar vision system will adjust its output resolution to match that of the 4D radar system.

A method of enhanced pixel resolution 4D ranging and detection using a stereo 4D radar vision system can further incorporate at least one of the following AI modules: occupancy network, 3D object detection, traffic sign and light recognition, lane departure detection, adaptive cruise control, forward collision detection and output at least one of the following: 4D semantic occupancy map, 4D cuboid coordinates, 4D semantic point cloud of the detected object, traffic sign and light information, lane departure warning information, adaptive cruise control signals, forward collision warning information, intermediate feature maps.

### DESCRIPTION OF THE FIGURES

FIG. 1 illustrates a prior art of a stereo vision system and a separated radar system.

FIG. 2 illustrates one embodiment of a stereo 4D radar vision system including a stereo vision system, a 4D radar system, a processor, a memory, and a network interface.

FIG. 3 illustrates the horizontal field of views of a stereo vision system and a 4D radar system.

FIG. 4 illustrates a perspective view frustum of the field of views of a stereo vision system and a 4D radar system.

FIG. 5 illustrates a flow chart of a method of enhanced pixel resolution 4D ranging and detection using a stereo 4D radar vision system

FIG. 6 illustrates a refined detected object boundary by using a panoptic segmentation mask.

FIG. 7 illustrates a flow chart of a method of enhanced pixel resolution 4D ranging and detection with a refined detected object boundary by using a panoptic segmentation mask.

FIG. 8 illustrates a flow chart of outputting with scanning resolution when reduced visibility is detected.

FIG. 9 illustrates a flow chart of a method of enhanced pixel resolution 4D ranging and detection using a stereo 4D radar vision system incorporating an AI module.

### DETAILED DESCRIPTION

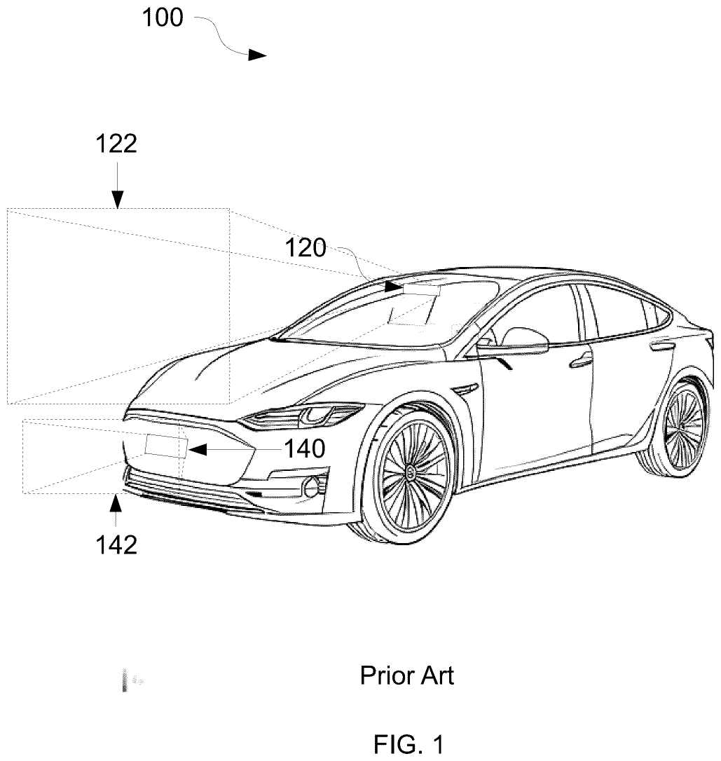

FIG. 1 shows a prior art stereo vision system and a separate radar system 100. In this example, the stereo vision system 120 is mounted behind the windshield of a car and may contain 2, 3, or 4 cameras, forming a field of view frustum 122. The separate radar system 140 is typically mounted behind the front bumper of the car, with a scanning field of view frustum 142. The stereo vision system is mounted a few meters behind the radar system at a higher position.

This construction has several drawbacks for integrating or fusing stereo vision and radar information. Firstly, there are blind spots in the viewing frustum where the stereo vision viewing frustum 122 does not overlap with the radar scanning frustum 142 at close distances. Secondly, when a vehicle turns, the angular distance and speed of an object detected by the stereo vision system will differ from that detected by the radar system. Thirdly, calibrating the two systems is more expensive and time-consuming due to their separation. Finally, the system is less robust due to its separated mounting and may require re-calibration over time due to accumulated assembly tolerance degradation over normal vibration during driving.

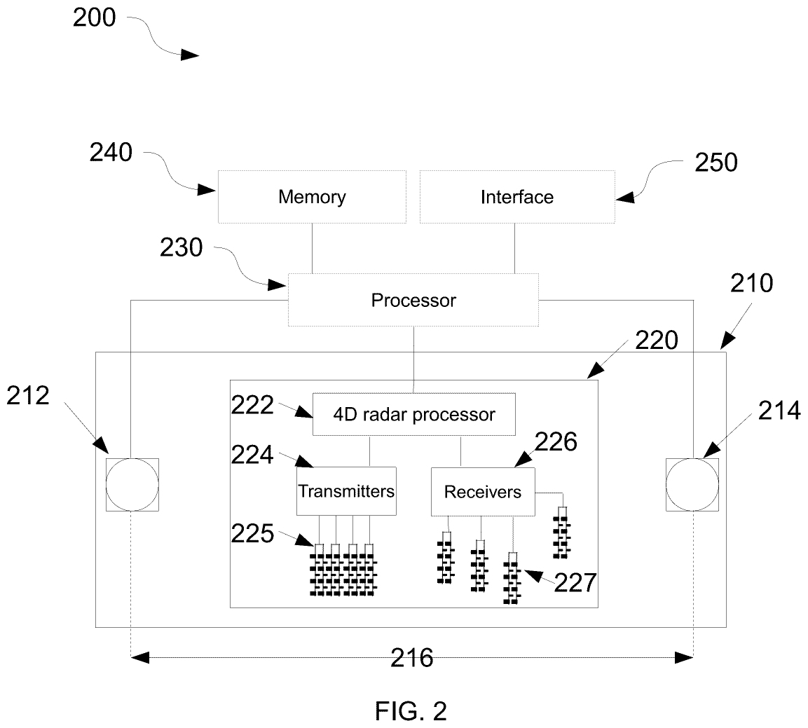

FIG. 2 is a schematic block diagram illustrating an example stereo 4D radar vision system 200. In this example, the system 200 includes two cameras 212, 214, a 4D radar 220, a processor 230, a memory 240, and a network interface 250. In the 4D radar 220, there are a 4D radar processor 222, an array of transmitters 224, an array of transmitting antennas 225, an array of receivers 226 and an array of receiving antennas 227.

In the example system, the system 200 is in communication with a car or robot navigation system (not shown in FIG. 2) via the network interface 250 using wired and/or wireless communication schemes.

In one of the preferred embodiments, the processor 230 is a MobilEye EyeQ Ultra with up to 176 TOPS computing power. In another embodiment, the processor 230 could be an embedded AI computing system such as NVIDIA Jetson Orin Nano that consists of a 1024-core GPU with 32 tensor cores and a 6-core ARM CPU. In yet another embodiment, the processor 230 could be a Rockchip RK3588 processor that has an 8-core ARM CPU and a 6 TOPS NPU.

In one of the preferred embodiments, the 4D radar 220 is an Arbe 4D Imaging Radar. It operates in the frequency range of 76-81 GHz. 4D represents that the unit can detect range (distance), Doppler (velocity) at azimuth and elevation coordinates. The resolutions of 4D are range resolution RRES=9.5 cm at 36 m, and 60 cm at 300 m, doppler resolution DRES=0.1 m/s, azimuth resolution ARES=1.25 degrees, and elevation resolution ERES=1.5 degrees. The detection space is range up to 300 m, Doppler −70˜+140 m/s, azimuth FOV 100 degrees, elevation FOV 30 degrees. It supports 48 transmitters and 48 receivers. This implies that the azimuth and elevation scanning resolution is 100/1.25×30/1.5=80×20=1,600 pixels per frame. The modulation scheme is enhanced FMCW with TD-MIMO.

The camera 212 and camera 214, connected to a processor 230 and a memory 240, form a stereo vision system 210. The transmitting antenna array 225 and the receiving antenna array 227, connected to an array of transmitters 224 and an array of receivers 226, respectively, and then connected to a 4D radar processor 222, form a 4D radar system 220 which is connected to the processor 230 and a memory 240.

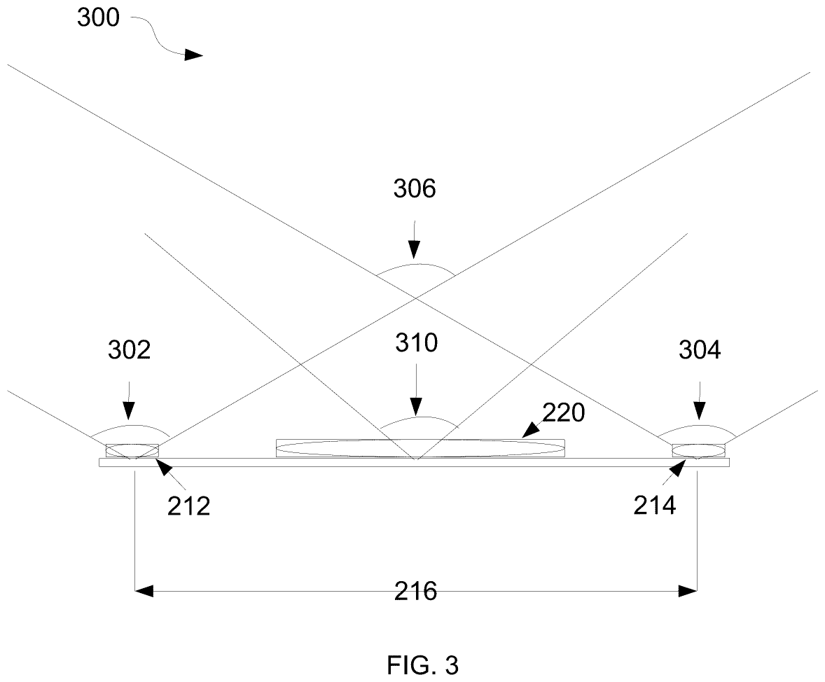

FIG. 3 illustrates an example configuration of the horizontal field of views of a stereo 4D radar vision system 200. The horizontal field of views 302, 304 of a stereo vision system 210 of camera 212 and camera 214 with the same focal length are overlapped into the stereo vision system horizontal field of view FOV1 306. The distance between the center of the horizontal field of view 302 of the camera 212 and the center of the horizontal the field of view 304 of the camera 214 is called baseline B1 216. The field of view 310 is the 4D radar horizontal scanning field of view FOV2.

In one of the preferred configurations, the stereo vision system 210 field of view FOV1 is greater than the 4D radar system 220 scanning field of view FOV2. The field of view FOV1 overlaps with more than 30% of the area of FOV2 in the range from 0.3 meters to 300 meters. The resolution of FOV1 is greater than the resolution of FOV2.

In one embodiment, in the stereo vision system 210, both camera 212 and camera 214 are using OmniVision OV9282 global shutter monochrome CMOS sensors with 1280×800 pixel resolution. The field of view FOV1 is 107 degrees horizontally and 70 degrees vertically. And the baseline B1 216 between camera 212 and camera 214 is 15 cm. In another embodiment, in the stereo vision system, both camera 212 and camera 214 are using Onsemi AR0234CS global shutter color CMOS sensors with 1920×1200 pixel resolution. The field of view FOV1 is 109 degrees horizontally and 69 degrees vertically. And the baseline B1 216 between camera 212 and camera 214 is 20 cm.

In another embodiment, both stereo vision system cameras are using extremely low-light sensitive Sony IMX485 to achieve even higher resolution of 3840×2160 to further improve the object distance estimate accuracy.

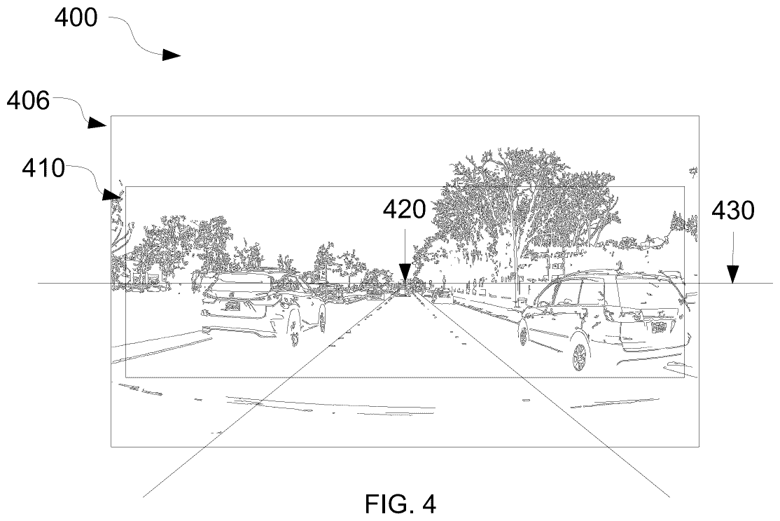

FIG. 4 illustrates a perspective view of the field of views of a stereo 4D radar vision system 400. The horizontal line 430 is the horizon of the perspective view. The point 420 is the vanishing point of the perspective view. The field of view 406 is the field of view FOV1 306 in the perspective view. The field of view 410 is the scanning field of view 310 FOV2 in the perspective view.

In one of the preferred embodiments, a stereo vision system 210 perspective field of view FOV1 406 center should align at the perspective view vanishing point 420. The 4D radar system 220 scanning perspective field of view FOV2 410 center should locate within the field of view FOV1 406.

In yet another preferred embodiments, all field of views FOV1 406, FOV2 410 centers should align at the perspective view vanishing point 420 with tolerance less than 20 cm.

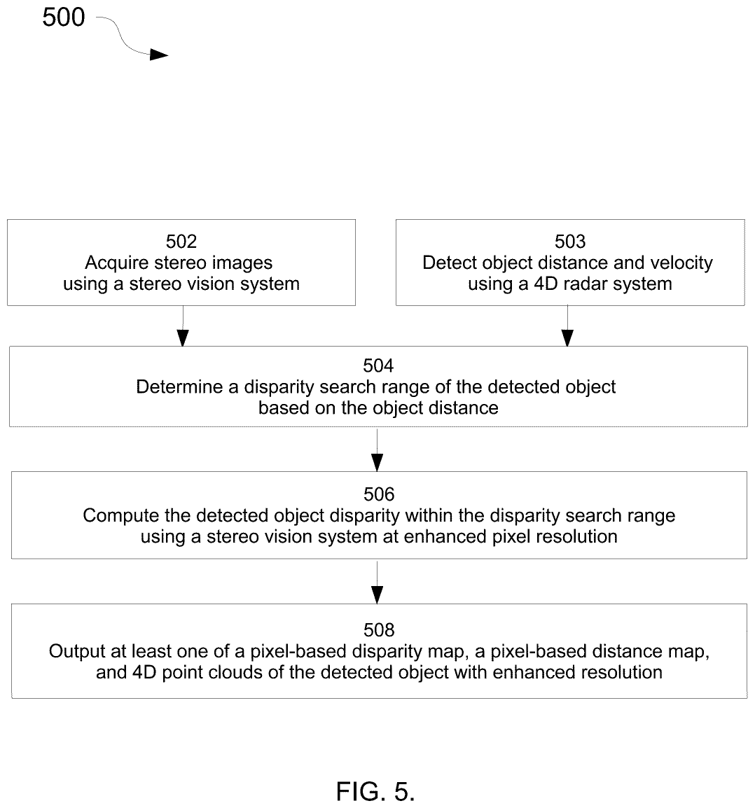

FIG. 5 illustrates a flow chart 500 of steps for a method of enhanced pixel resolution 4D ranging and detection using a stereo 4D radar vision system. Steps 502 and 503 are parallel steps for acquiring synchronous image and scanning frames from a stereo vision system 210 and a 4D radar system 220. Step 502 can be processed in the processor 230. Step 503 can also be processed in the 4D radar processor 222 in parallel.

In step 502, cameras 212 and 214 acquire stereo images controlled by the processor 230. In one of the preferred embodiments, the stereo image resolutions are 1920×1200 pixels with a field of view FOV1 of 109 degrees HFOV by 69 degrees VFOV at a frame rate of 30 fps (frames per second) with a baseline B1 216 of 20 cm.

In step 503, synchronously with step 502, a 4D radar system 220 detects at least one object with 4D information of azimuth (as A in degrees), elevation (as E in degrees), range (or distance as D in meters), and Doppler (or velocity as V in meters/second) within a frame time. In one of the preferred embodiments, the 4D radar has a scanning resolution of 80×20 (azimuth by elevation) positions with a field of view FOV2 of 100 degrees HFOV (azimuth) by 30 degrees VFOV (elevation) at a frame rate of 30 fps.

Compared with the stereo image resolution, the 4D radar scanning resolution is significantly lower. Thus, we call the stereo image resolution an enhanced pixel resolution to differentiate it from the 4D radar scanning resolution. OFOV1 is the overlap field of views FOV1 and FOV2. In OFOV1, the enhanced resolution has a horizontal enhanced factor HF and a vertical enhanced factor VF over the scanning resolution.

In this one of the preferred embodiments, OFOV1 has a field of view of 100 degrees HFOV by 30 degrees VFOV with an enhanced resolution of 1760×520 pixels and a scanning resolution of 80×20 positions. Each scanning position (azimuth, elevation) corresponds to about 22×26 pixels in enhanced resolution. Thus in this embodiment the horizontal enhanced factor HF is 22 and the vertical enhanced factor VF is 26.

In step 504, a disparity search range R, associated with an object (A, E, D, V) detected by a 4D radar system in step 503, is defined as (disparity−delta, disparity+delta). Where disparity is defined as (focal_length*baseline(B1))/(pixel_size*distance (D)), and delta could be a constant, or a percentage of disparity, or a combination of both. For example, delta=min(constant, percentage of disparity).

In one of the preferred embodiments, the focal_length is 2.8 mm, the baseline is 20 cm, the pixel_size is 3 microns (um) and the delta is 1. For example, if the distance D of a detected object is 30 m away, then the disparity search range R for this object is (2.8 mm*20 cm/(3 um*30 m)−1, 2.8 mm*20 cm/(3 um*30 m)+1), that is, R=(6.22-1, 6.22+1)=(5.22, 7.22).

In step 506, a disparity map is computed for an enhanced pixel resolution region ER corresponding to the detected object position (A, E). Each pixel disparity within the ER is computed as the minimal stereo matching cost position between the left and right image pair, using the disparity search range R determined in step 504.

In one of the preferred embodiments, for instance, an object is detected at a distance of 30 meters with an azimuth scanning position of A=0 degrees and an elevation of E=1.5 degrees with a horizontal enhanced factor HF=22 and a vertical enhanced factor VF=26. This corresponds to an ER of 22×26 pixels centered at pixel position X=880 and Y=286 (calculated as half of 1760 and half of 520 plus the adjustment for elevation). The associated disparity search range R for the object (A, E, D, V)=(0 degrees, 1.5 degrees, 30 meters, 4.47 m/s) is (5.22, 7.22).

It is widely recognized in the field that larger disparity search ranges R tend to result in lower pixel disparity accuracy. For example, when using a fixed and large disparity search range like (0, 256) for all enhanced pixel resolution regions ER, there is a higher occurrence of false or ambiguous minimal stereo matching cost positions compared to a smaller and dynamically determined disparity search range like (5.22, 7.22). This discrepancy is influenced by factors such as noise in the area, the absence of depth information in occluded regions, lack of texture or repetitive texture patterns, and the competing criteria dilemma of local versus global matching cost optimization (Object Disparity by Ynjiun Paul Wang, published on Aug. 18, 2021, in arXiv:2108.07939). Thus, the current invention's dynamic and narrow disparity search range significantly enhances the accuracy of the ER disparity map, especially in areas with noise, repetitive textures, lack of textures, and occlusions.

In one of the preferred embodiments, both stereo left/right images can be rectified, and feature extraction techniques such as edge detection or census transform can be performed before computing stereo disparity. An example of computing disparity as finding the minimal stereo matching cost position between the left and right image pair in a fixed default disparity search range is called “Stereo Matching Based on Improved Census Transform” and was published in the 2018 IEEE 4th International Conference on Computer and Communications by Y. Jia et al. A modification of this example stereo matching algorithm needs to be made to be applicable for the current invention in step 506. Specifically, the fixed default disparity search range needs to be replaced by a dynamically determined disparity search range in step 504.

Another example of disparity estimation is performed by neural network algorithm, such as the “Pyramid Stereo Matching Network” published in the Conference on Computer Vision and Pattern Recognition (CVPR) in 2018 by J. R. Chang and Y. S. Chen. A similar modification, replacing a fixed default disparity search range with a dynamically determined disparity search range, is required to make it applicable for the current invention in step 506.

Furthermore, the resulting disparity map can be further refined to achieve sub-pixel accuracy by applying parabolic curve fitting to a local neighborhood of global maximal correlation. This approach is exemplified in a paper titled “High Accuracy Stereovision Approach for Obstacle Detection on Non-Planar Roads” by Nedevschi, S. et al., published in the Proceedings of the IEEE Intelligent Engineering Systems (INES) on 19-21 Sep. 2004, pages 211-216.

In step 508, an ER disparity map with an enhanced pixel resolution of HF×VF pixels, associated with a detected object position, is output through interface 250.

An ER distance map with an enhanced pixel resolution of HF×VF pixels, associated with a detected object position, can also be output through interface 250.

To convert the ER disparity map into an ER distance map, the following formula can be applied to each pixel:

distance=(focal_length*baseline)/(pixel_size*disparity) (Eq. 1)

This formula (Eq. 1) calculates the distance to the object based on the focal length, baseline, pixel size, and pixel disparity.

In addition to the ER disparity map and ER distance map, a 4D point clouds of the detected object can be output as well. Given a detected object (A degrees, E degrees, D m, V m/s), an enhanced resolution 4D point clouds E4DPC can be determined by an ER distance map and its associated HF×VF pixels coordinates. Assuming the object detected is a rigid object, therefore all the enhanced resolution point clouds velocity Vij values are the same as V m/s. Each point distance Dij will be the correspont pixel distance in the ER distance map. Each point's azimuth and elevation in E4DPC will be translated as Ai=A+(i−HF/2)*ARES/HF degrees, Ej=E+(j−VF/2)*ERES/VF, where i is in the range of (0, HF) and j is in the range of (0, VF).

In one of the preferred embodiments, a stereo 4D radar vision system 200 with a horizontal enhanced factor HF=22, a vertical enhanced factor VF=26, azimuth resolution ARES=1.25 degrees, elevation resolution ERES=1.5 degrees, detects an object at (A, E, D, V)=(0 degrees, 1.5 degrees, 30 meters, 4.47 m/s). The ER distance map ERD is determined by formula (Eq. 1) using the ER disparity map computed by step 506. The ERD has a total of HF×VF=22×26 distance components denoted as Dij where i is in (0, 22), j is in (0, 26). The enhanced resolution 4D point clouds E4DPC is therefore determined as {(Ai degree, Ej degree, Dij m, 4.47 m/s)}={(0+(i−22/2)*1.25/22 degree, 1.5+(j−26/2)*1.5/26 degree, Dij m, 4.47 m/s)} where i is in (0, 22) and j is in (0, 26).

Although only one detected object is described in steps 502, 503, 504, 506 and 508, it is understood in the field of art that multiple objects can be detected and processed by the same method in parallel or iteratively without loss of generality.

The distance map and 4D point clouds output of the current invention is called an evidence-based output because the distance and velocity of a detected object are from actual measurement according to the law of physics. This is different from an inference-based output found among many prior arts which relies on an AI model inference that might introduce errors in an environment never covered by a training dataset.

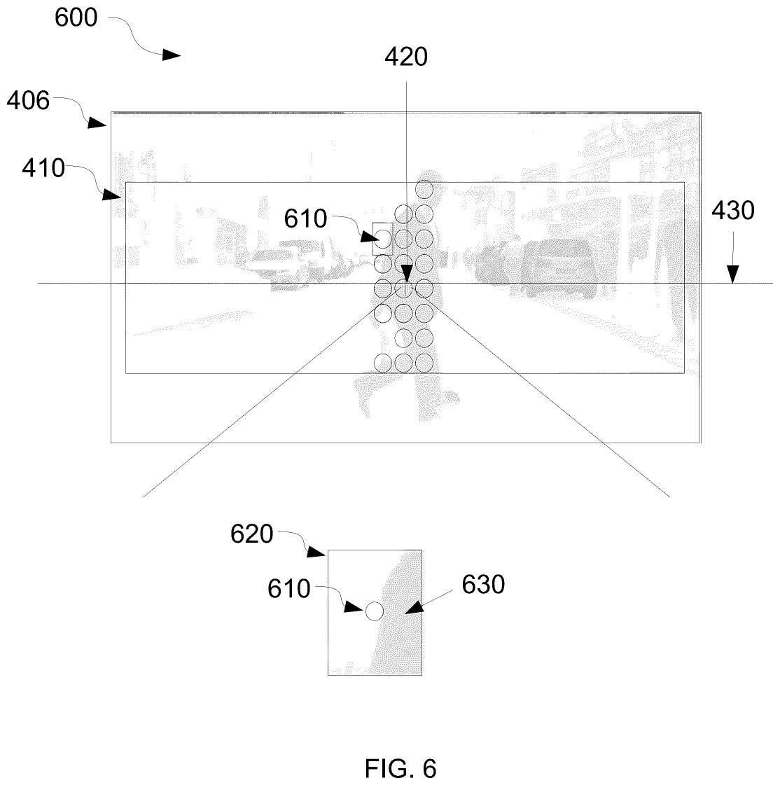

In step 504, the disparity search range may not apply to all the pixels in the enhanced pixel resolution region ER if the detected object does not extend to the entire HF×VF pixels in enhanced resolution. For example, as shown in FIG. 6, a pedestrian crossing a street is detected by a stereo 4D radar vision system 200. Each circle 610 in the 4D radar scanning FOV2 410 represents that an object has been detected within the unit ARES×ERES scanning field of view. Multiple detected objects (circles) may be grouped into one instance, for example, a pedestrian which is occupying a field of view larger than a unit ARES×ERES scanning field of view 620.

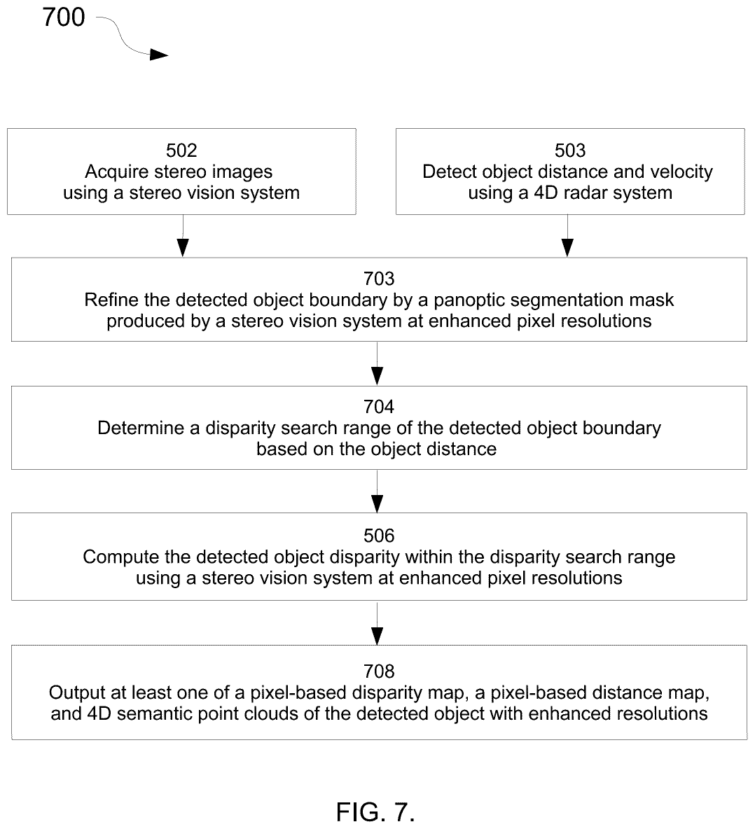

In step 703 of FIG. 7, a panoptic segmentation algorithm can be applied to stereo images to extract an instance mask by the stereo vision system at enhanced pixel resolutions. For example, a shaded area 630 in FIG. 6 represents a pedestrian instance mask within the scanning unit field of view 620. An example panoptic segmentation algorithm called “OneFormer: One Transformer to Rule Universal Image Segmentation,” published in CVPR 2023 by J. Jain et al., can be used in step 703.

In step 704, a disparity search range R of a detected object only applies to the pixels within the detected object boundary covered by the instance mask area extracted in step 703.

It is possible to have multiple instance masks within an ER corresponding to a unit ARES×ERES scanning field of view. A different disparity search range R will be assigned to each different mask accordingly. The extreme case could be each pixel in an ER can be assigned a different disparity range R, thus forming a HF×VF dimension disparity search range map R_{ER}. In this case, in step 506, the ER disparity map computation will apply disparity search range map R_{ER} to each corresponding pixel in enhanced resolutions.

In step 708, it is the same as step 508, except that the 4D point clouds output can be further augmented to 4D semantic point clouds by adding the predicted segmentation class from the panoptic segmentation algorithm in step 703 to each point.

The panoptic segmentation algorithms used in step 703 can be further extended to include a classification category of reduced visibility RV in adverse weather conditions, such as fog, rain, snow, or extremely dark environments.

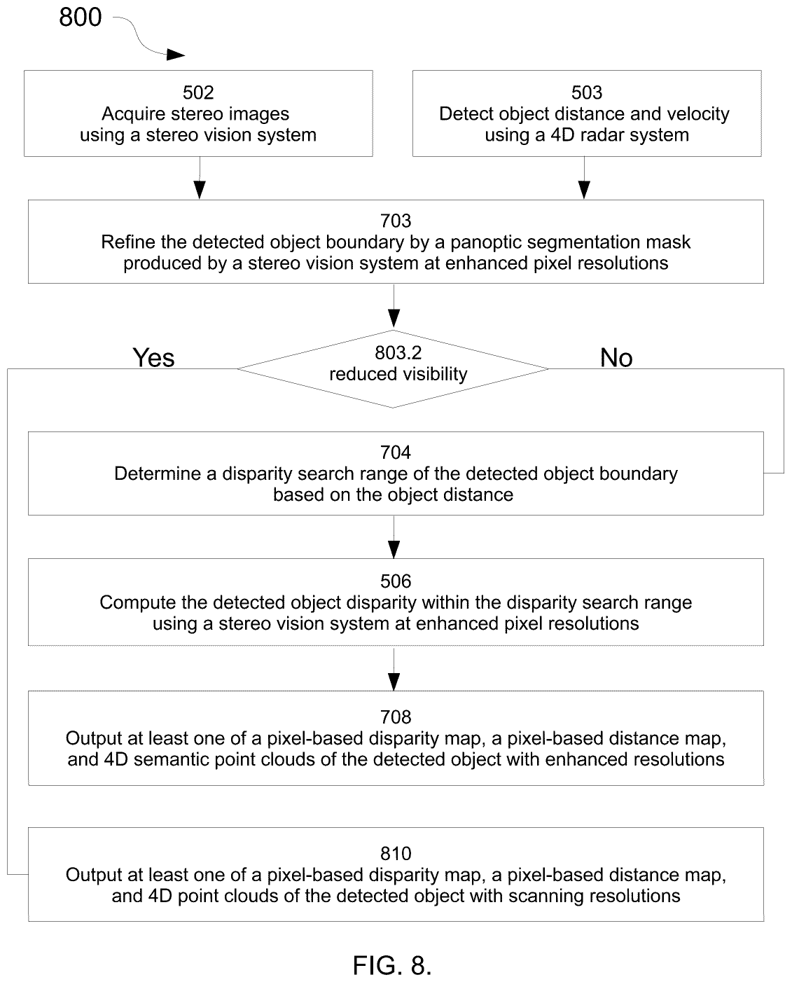

In step 803.2 of FIG. 8, if a reduced visibility is detected by step 703, then step 810 is performed. In step 810, the stereo 4D radar vision system 200 outputs at least one of a pixel-based disparity map, a pixel-based distance map, and 4D point clouds of the detected object with scanning resolution.

Although steps 502, 503, 703, 803.2, 704, 506, 708, and 810 describe only one detected object, it is understood in the field that the same method can detect and process multiple objects in parallel or iteratively without loss of generality. Particularly, some objects may be detected with reduced visibility while others are not. As a result, there may be a mix of outputs with scanning and enhanced resolutions within a frame.

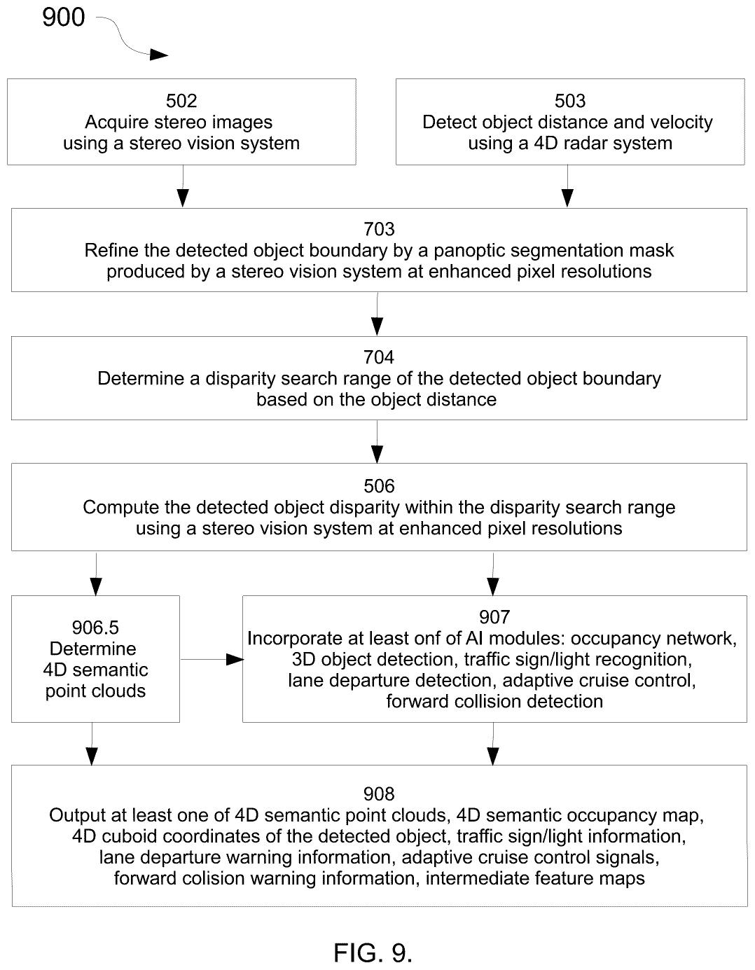

In FIG. 9, a flow chart 900 illustrates a method of enhanced pixel resolution 4D ranging and detection using a stereo 4D radar vision system that can further incorporate at least one of the following AI modules: occupancy network, 3D object detection, traffic sign recognition, traffic light recognition, lane departure detection, adaptive cruise control, forward collision detection and output at least one of the following: 4D semantic point clouds, 4D semantic occupancy map, 4D cuboid coordinates of the detected object, traffic sign information, traffic light information, lane departure warning information, adaptive cruise control signals, forward collision warning information, intermediate feature maps.

In step 906.5, the 4D semantic point clouds of the detected object can be determined by the same process described in steps 508 and 708, without incorporating an AI module, and can be output directly in step 908.

In step 907, an occupancy network can be incorporated to output a 4D semantic occupancy map of the detected object with enhanced resolution in step 908. An example of an occupancy network is called TPVFormer, presented in the paper “Tri-Perspective View For Vision-Based 3D Semantic Occupancy Prediction” by Y. Huang, et al., published on Mar. 2, 2023, in arXiv: 2302.07817v2 [cs.CV]. A few modifications might be needed to incorporate this AI module into step 907. First, the six surrounding cameras input will be changed to the two cameras from the stereo vision system 210. The model needs to be retrained accordingly. Second, the 3D semantic occupancy predictions need to be augmented to 4D semantic occupancy predictions by adding the velocity component detected by the 4D radar system 220 with enhanced resolution in step 906.5. The 3D coordinates of the occupancy predictions also need to be corrected by the evidence-based 3D coordinates from the 4D semantic point clouds determined in step 906.5.

In another preferred embodiment, in step 907, a 3D object detection AI module can be incorporated to output 4D cuboid coordinates of the detected object with enhanced resolution in step 908. An example of a 3D object detection AI module is presented in the paper titled “SE-SSD: Self-Ensembling Single-Stage Object Detector From Point Cloud” by Wu Zheng, et al., published on Apr. 20, 2021, in arXiv: 2104.09804 [cs.CV]. Several modifications are needed to incorporate this AI module into step 907. First, the 3D point cloud input will be changed to a 4D semantic point cloud input from the output of step 906.5. Second, the output of 3D cuboid coordinates of this AI module will be augmented to 4D cuboid coordinates by transferring the velocity and semantic components from the 4D semantic point clouds input.

The semantic component of the 4D semantic point clouds can identify and classify various objects on the road, including vehicles, pedestrians, cyclists, traffic signs, and traffic lights.

In yet another preferred embodiment, a traffic sign recognition AI module can be incorporated in step 907. It can identify and interpret traffic signs, including speed limits, stop signs, and other regulatory signs, and output relevant traffic sign information in step 908 to the driver or the autonomous driving planning and control system (not shown in the FIG. 9).

An example of a traffic sign recognition AI module is presented in a paper titled “TRD-YOLO: A Real-Time, High-Performance Small Traffic Sign Detection Algorithm” by J. Chu, et al., published on Apr. 10, 2023, in Sensors, MDPI.

Additionally, a traffic light recognition AI module can be incorporated in step 907. It can detect and recognize traffic lights, and output traffic light information in step 908 to the driver or the autonomous driving planning and control system by informing of the current signal state or providing guidance for optimal driving behavior.

An example of a traffic light recognition AI module is called “An innovative traffic light recognition method using vehicular ad-hoc networks” by E. Al-Ezaly, et al., published on Mar. 10, 2023, in Scientific Reports 13, Article number: 4009 (2023).

In step 907, a lane departure detection AI module can be incorporated. It can analyze lane markings and output the lane departure warning information in step 908 to the driver or the autonomous driving planning and control system if the vehicle deviates from its lane without signaling.

Examples of lane departure detection AI modules can be found in “Lane departure warning systems and lane line detection methods based on image processing and semantic segmentation: A review” by W. Chen, et al., published in December 2020, in Journal of Traffic and Transportation Engineering 7(6):748-774.

In another preferred embodiment, an adaptive cruise control AI module can be incorporated in step 907. This module can output vehicle speed and brake signals as adaptive cruise control (ACC) signals in step 908 to maintain a safe distance from the vehicle ahead.

An example of an adaptive cruise control AI module is presented in the paper called “Research on adaptive cruise control algorithm considering road conditions” by Z. Yang, et al., published on Aug. 9, 2021, in IET Intelligent Transport Systems, 1478-1493 (2021).

In yet another preferred embodiment, a forward collision detection AI module can be incorporated in step 907. This module can detect potential frontal collisions with vehicles or obstacles, such as pedestrians and cyclists, and output forward collision warning (FCW) information in step 908 to alert the driver or the autonomous driving planning and control system to take corrective action.

An example of a forward collision detection AI module is called “An Adaptive Multi-Staged Forward Collision Warning System Using a Light Gradient Boosting Machine” by J. Ma, et al. published on Jul. 26, 2022, in Information 2022, 13(10), 483.

The input of all above examples of AI modules, including traffic sign recognition, traffic light recognition, lane departure detection, adaptive cruise control, forward collision detection, needs to be modified to accept at least one of the 4D semantic point clouds from step 906.5 and stereo images from step 502.

In step 908, it is possible to output intermediate feature maps from an AI module in step 907. For example, if the TPVFormer occupancy network AI module is incorporated in step 907, then it is possible to output the multi-scale features extracted from the image backbone network employed by the TPVFormer as intermediate feature maps.

The flow diagrams depicted herein are just examples of the current invention. There may be many variations to these diagrams or the steps (or operations) described therein without departing from the spirit of the disclosure. For instance, the steps may be performed in a differing order, or steps may be added, deleted or modified.

While various embodiments have been described, it will be understood that those skilled in the art, both now and in the future, may make various improvements and enhancements which can be made.

What is claimed is:

1. An stereo 4D radar vision system, comprising:
a stereo vision system with a field of view FOV1 and baseline B1,
a 4D radar system with a field of view FOV2,
wherein, FOV1 and FOV2 overlap in the range of 1 meter to 300 meters.

2. The stereo 4D radar vision system of claim 1, wherein FOV1 overlaps with more than 30% of the area of FOV2 in the range of 0.3 meter to 300 meters.

3. The stereo 4D radar vision system of claim 1, wherein FOV1 has higher pixel resolutions than FOV2.

4. The stereo 4D radar vision system of claim 1, wherein the center of FOV1 is at a distance of less than 20 cm away from the center of FOV2.

5. The stereo 4D radar vision system of claim 1, wherein the baseline B1 is at least 10 cm.

6. A method of enhanced pixel resolution 4D ranging and detection using a stereo 4D radar vision system, comprising:
Acquiring stereo images using a stereo vision system at enhanced pixel resolution,
Detecting object distance and velocity using a 4D radar system at scanning resolution,
Determining a disparity search range of the detected object based on the object distance detected by the 4D radar system,
Computing the detected object disparity within the disparity search range using a stereo vision system at enhanced pixel resolution,
Outputting at least one of a pixel-based disparity map, a pixel-based distance map, and 4D point clouds of the detected object with enhanced resolution.

7. The method of enhanced pixel resolution 4D ranging and detection using a stereo 4D radar vision system of claim 6, wherein a boundary of the detected object can be refined by a panoptic segmentation mask extracted by the stereo vision system at enhanced pixel resolution.

8. The method of enhanced pixel resolution 4D ranging and detection using a stereo 4D radar vision system of claim 7, incorporates a panoptic segmentation mask that includes a category for reduced visibility in an adverse weather conditions.

9. The method of enhanced pixel resolution 4D ranging and detection using a stereo 4D radar vision system of claim 8, wherein outputting at least one of a pixel-based disparity map, a pixel-based distance map, and 4D point clouds of the detected object with scanning resolution when reduced visibility is detected.

10. A method of enhanced pixel resolution 4D ranging and detection using a stereo 4D radar vision system, comprising:
Acquiring stereo images using a stereo vision system at enhanced pixel resolution,
Detecting object distance and velocity using a 4D radar system at scanning resolution,
Refining a boundary of the detected object by a panoptic segmentation mask extracted by the stereo vision system at enhanced pixel resolutions,
Determining a disparity search range of the detected object boundary based on the object distance detected by the 4D radar system,
Computing the detected object disparity within the disparity search range using a stereo vision system at enhanced pixel resolution,
Incorporating at least one of AI modules: occupancy network, 3D object detection, traffice sign and light recognition, lane departure detection, adaptive cruise control, forward collision detection,
Outputting at least one of 4D semantic occupancy map, 4D cuboid coordinates, 4D semantic point clouds of the detected object, traffic sign and light information, lane departure warning information, adaptive cruise control signals, forward collision warning information, intermediate feature maps.
